(19) United States
(12) Patent Application Publication
(10) Pub. No.: US 2010/0140351 A1
(43) Pub. Date: Jun. 10, 2010

(54) METHOD FOR PREVENTING ARTICLE THEFT AND SELF-CHECKOUT SYSTEM CARRYING OUT THE METHOD

(75) Inventor: Peter Trenciansky, Mississauga (CA)

Correspondence Address: BAKER & DANIELS LLP;111 E. WAYNE STREET, SUITE 800, FORT WAYNE, IN, 46802, US

(73) Assignee: Sentry Technology Corporation, Ronkonoma, NY (US)

(21) Appl. No.: 12/329,992

(22) Filed: Dec. 8, 2008

(51) Int. Cl. G06Q 30/00; G06F 7/04; G06K 19/00

(52) U.S. Cl. 235/383; 340/5.8; 235/487; 235/462.01

(57) ABSTRACT

A method of inhibiting article theft at a location employing at least one-self checkout station and an antitheft security system, each article carrying at least one antitheft label, comprises reading information from an article, sensing at least one physical parameter of the article, retrieving article parameter information from a database based on the read identification information, comparing the sensed the at least one physical parameter with the retrieved article parameter information and deactivating each antitheft security label carried by the article if the sensed at least one physical parameter generally corresponds with the article parameter information.

### FIELD OF THE INVENTION

The present invention relates generally to theft prevention and in particular, to a method for preventing article theft at a location employing at least one self-checkout station and an antitheft security system, and to a self-checkout system carrying out the method.

### BACKGROUND OF THE INVENTION

Most libraries employ an electromagnetic antitheft security (EAS) system to protect against theft. As is well known with such an EAS system, books, magazines, compact disks (CDs), digital video disks (DVDs), video and tape cassettes and other library items or assets are tagged with one or more EAS labels. An EAS label detector is typically positioned at the entrances and exits of the libraries. When a library item having an activated EAS label is brought in proximity to the EAS label detector, an alarm in the EAS system is sounded. At checkout, the EAS label(s) on each library item to be checked out of the library is deactivated by an EAS label desensitizer that subjects each library item in its deactivation space to a strong magnetic field. With the EAS labels deactivated, library items can be passed through the EAS label detector without causing the EAS system alarm to sound.

When library items are checked out at conventional manned checkout stations, it is easy for library staff to ensure that each library item is properly checked out so that accurate transaction records for the checked out library items exist. Self-checkout systems are however becoming increasingly popular and a growing number of libraries are installing computerized self-checkout systems to permit patrons to self-check books and other items into and out of the libraries as such self-checkout systems provide many advantages both to library staff and to patrons.

Known self-checkout systems for libraries include for example, the SelfCheck™ system sold by 3M Library Systems of St. Paul, Minn., U.S.A., and the QuickCheck™ system sold by Sentry Technology Corporation of Toronto, Ontario, Canada. These self-checkout systems communicate with the integrated library system (ILS) that is responsible for managing library item records, recording transactions, managing library patron accounts etc. During checkout of a library item using such a self-checkout system, the patron is prompted to scan a barcode label on the library item and a barcode label on their library identification (ID) card. The information read from the barcode label on the patron's ID card is conveyed to the ILS to determine if the patron's account is in good order. If so, the information read from the library item barcode label is conveyed to the ILS so that the transaction can be recorded. Once the transaction has been recorded, the ILS signals the EAS label desensitizer, which in response outputs a strong magnetic field in its deactivation space thereby to deactivate the EAS label(s) on the library item allowing the library item to be removed from the library without the EAS system alarm sounding.

As will be appreciated, by employing self-checkout systems, fewer library staff members are needed at peak times. Also, library staff members can be freed to assist patrons in their searches for information and library items. Repetitive strain injuries resulting from the handling of books and other library items are reduced. In addition, patron privacy is improved and patron waiting times are reduced. While these self-checkout systems work very well, they have inadvertently created problems by opening an opportunity for theft.

At a self-checkout system such as those mentioned above, during the checkout process, if a patron places two library items, one under the other, in the deactivation space of the EAS label desensitizer but only scans the barcode label(s) on the top library item, when the EAS label desensitizer is activated, the EAS label on both library items will be deactivated allowing the patron to remove both items from the library without the EAS system alarm sounding even though only one library item has been properly checked out. The problem is compounded as the number of library items placed one on top of the other in the deactivation space of the EAS label desensitizer increases.

In order to stop theft of this nature, the self-checkout system must be able to detect the presence of all library items placed in the deactivation space of the EAS label desensitizer. The most widely used library item presence sensor employs an electronics module to detect the presence of more than one EAS label in the deactivation space of the EAS label desensitizer and so infer that multiple library items are present in the deactivation space. Unfortunately, this approach is not always reliable because some library items may carry more than one EAS label. Examples of library items that commonly carry more than one EAS label include but are not limited to casings holding multiple CDs or DVDs, each carrying its own EAS label, as well as magazines that are bound together after circulating individually. Conversely, some library items may not have EAS labels or may have improperly deactivated EAS labels. In these latter cases, the library item presence sensor is simply unable to detect the presence of the library items in the deactivation space of the EAS label desensitizer.

As will be appreciated, improvements in theft prevention of library assets and in fact assets in general are desired. It is therefore an object of the present invention to provide a novel method for preventing article theft at a location employing at least one self-checkout system and an antitheft security system, and a self-checkout system carrying out the method.

### SUMMARY OF THE INVENTION

Accordingly, in one aspect there is provided a method of inhibiting article theft at a location employing at least one self-checkout station and an antitheft security system, each article carrying at least one antitheft security label. The method comprises reading identification information from an article; sensing at least one physical parameter of the article; retrieving article parameter information from at least one database based on the read identification information; comparing the sensed at least one physical parameter with the retrieved article parameter information; and deactivating each antitheft security label carried by the article if the sensed at least one physical parameter generally corresponds with the article parameter information.

In one embodiment, the antitheft security label is deactivated if the sensed at least one physical parameter does not deviate from the retrieved article parameter information by more than a threshold amount. The threshold amount is a function of the article type.

In one embodiment, during the sensing, at least one of weight, thickness and shape of the article is sensed. During the reading, at least one identification label on the article is read for the identification information. In one form, at least one of a barcode label and a radio frequency identification (RFID) label on the article is read for the identification information. When identification information is read from both the barcode label and the RFID label, the identification information is compared to detect coincidence prior to the retrieving. The retrieving, comparing and deactivating is performed only upon coincidence of the identification information read from both the barcode label and RFID label.

In one embodiment, if article parameter information for the article does not exist in the at least one database, the sensed at least one physical parameter is stored in the at least one database as the article parameter information and the deactivating is performed. During the comparing, if the sensed at least one physical parameter does not generally correspond with the article parameter information, the deviation in the compared information is examined to determine if it is the result of a likely error in the article parameter information. If so, the deactivating is performed. In this case, the article parameter information is updated using the sensed at least one physical parameter and a suspicious transaction event is recorded.

According to another aspect there is provided a self-checkout system comprising at least one reader for reading information from an article; at least one sensor for sensing at least one physical parameter of the article; processing structure communicating with the at least one reader and the at least one sensor and comparing the sensed at least one physical parameter with article parameter information read from at least one database; and an antitheft security label deactivator for deactivating an antitheft security label carried by the article when the sensed at least one physical parameter generally corresponds to the article parameter information.

According to yet another aspect there is provided a computer readable medium embodying a computer program, the computer program comprising: computer program code for causing a reader to read identification information from an article; computer program code for causing a sensor to sense at least one physical parameter of the article; computer program code for retrieving article parameter information from at least one database based on the read identification information; computer program code for comparing the sensed at least one physical parameter with the retrieved article parameter information; and computer program code for causing a deactivator to deactivate each antitheft security label carried by the article if the sensed at least one physical parameter generally corresponds with said article parameter information.

### BRIEF DESCRIPTION OF THE DRAWINGS

Embodiments will now be described more fully with reference to the accompanying drawings in which:

FIG. 1 is a schematic block diagram of a self-checkout system installed in a library; and

FIG. 2 is a flowchart showing the steps performed when a library item is checked out of the library using the self-checkout system of FIG. 1.

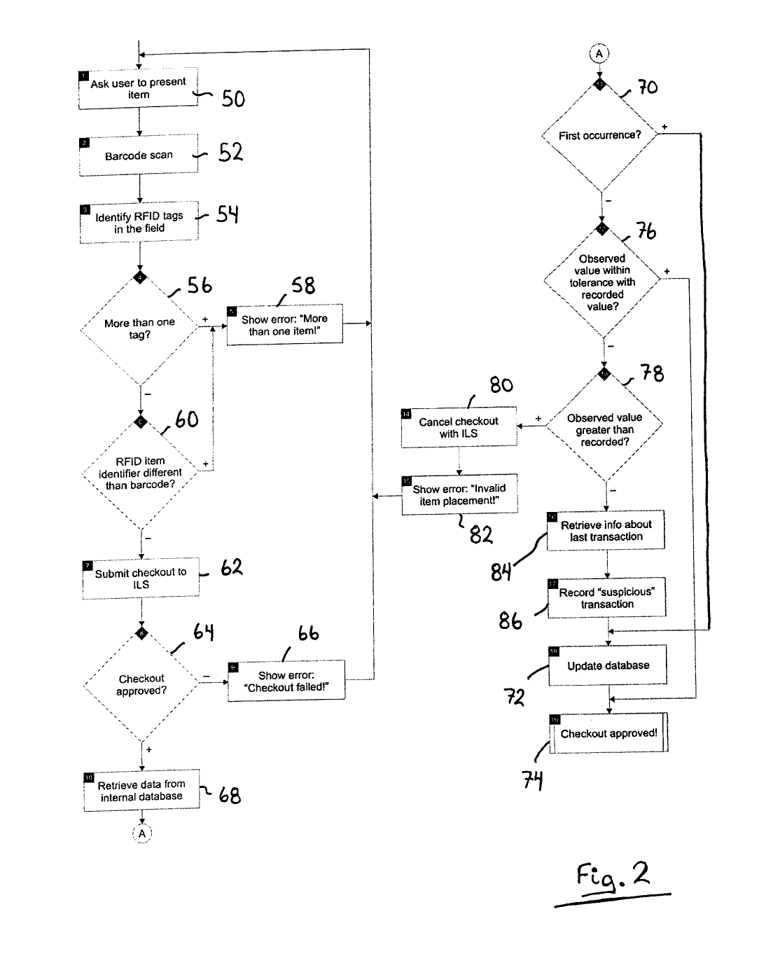

### DETAILED DESCRIPTION OF THE EMBODIMENTS

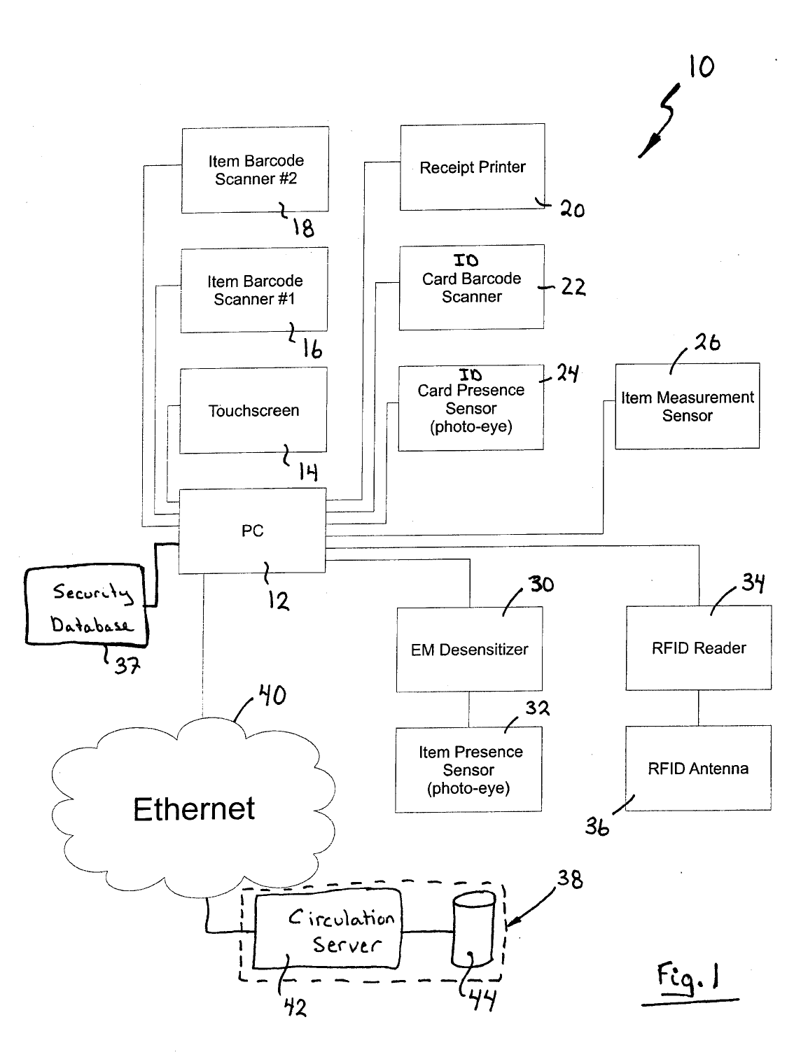

Turning now to FIG. 1, a self-checkout system installed in a library employing an electromagnetic antitheft security (EAS) system is shown and is generally identified by reference numeral 10. As can be seen, the self-checkout system 10 comprises a central processor 12 in the form of a personal computer (PC) or other suitable processing device having a touchscreen display 14. The personal computer 12 executes a checkout software application and communicates with a plurality of components or modules. In this example, the personal computer 12 communicates with a plurality of library item barcode label scanners 16 and 18 respectively, a receipt printer 20, an identification (ID) card barcode label scanner 22, an ID card presence sensor 24 and a library item measurement sensor 26. The personal computer 12 also communicates with an EAS label desensitizer 30, a library item presence sensor 32 and a radio frequency identification (RFID) label reader 34 having an RFID antenna 36. The personal computer 12 further communicates with a security database 37 and with an integrated library system (ILS) 38 via a wired or wireless local area network (LAN) 40.

The security database 37 stores physical characteristic or parameter and other information relating to library items. In particular, the security database 37 stores library item records with each record being associated with a particular library item. Each library item record in this embodiment comprises a thickness value, library item ID data corresponding to the barcode and RFID data on the particular library item, the date and time on which the library item record was created, the checkout station that was used during creation of the library item record and the ID number of the patron involved in the transaction that resulted in the creation of the library item record. The security database 37 also stores security policies for library item types and an audit trail of recorded suspicious transactions. The ILS 38 is responsible for managing library item records, managing patron accounts, recording library item transactions etc. and in this embodiment comprises a circulation server 42 and one or more databases generally identified by reference numeral 44.

The library item measurement sensor 26 measures one or more physical parameters of each library item placed in its sensing space. In this embodiment, the library item measurement sensor 26 measures the thickness of each library item placed on the processing plate of the EAS label desensitizer 30. To achieve this, in this embodiment the library item measurement sensor 26 comprises an ultrasonic sensor unit such as those manufactured by Baumer Electric AG of Switzerland under product family UNAM 12 that emits ultrasound waves towards the processing plate of the EAS label desensitizer 30 and that receives reflected ultrasound waves either from the processing plate of the EAS label desensitizer 30 or from the library item placed thereon. The ultrasonic sensor unit is calibrated based on the time taken for emitted ultrasound waves to travel to the processing plate of the EAS label desensitizer 30, reflect off of the processing plate and return to the ultrasonic sensor unit. When a library item is placed on the processing plate of the EAS label desensitizer 30, the time taken for emitted ultrasound waves to return to the ultrasonic sensor unit is reduced as the top of the library item is closer to the ultrasonic sensor unit than the processing plate. The difference in time taken is proportional to the height of the top of the library item above the processing plate and hence, the thickness of the library item. As a result, in response to transmitted and received ultrasound waves, the ultrasonic sensor unit uses the time taken for the ultrasound waves to travel to the library item placed on the processing plate and return to the ultrasonic sensor unit to calculate the thickness of the library item placed on the processing plate.

In this embodiment, all of the library items or assets such as for example books, CDs, DVDs, video and tape cassettes, magazines etc. are tagged with one or more EAS labels that are activated while the items are properly checked into the library and deactivated when the items are properly checked out of the library. In this manner, if a patron tries to remove an item from the library without first properly checking the item out of the library, the alarm of the EAS system is triggered by the activated EAS label(s) on the library item. Each library item is also tagged with a barcode label and an RFID label. The barcode label and the RFID label each contain identification (ID) data specific to the library item. Each RFID label in this embodiment operates at 13.56 MHz and is ISO 15693 and ISO 18000 compatible.

When a patron wishes to use the self-checkout system 10 in order to check one or more items out of the library and selects a checkout prompt displayed on the touchscreen display 14, the personal computer 12, in response to the checkout prompt selection, executes the checkout software application. During execution of the checkout application, the personal computer 12 presents a prompt on the touchscreen display 14 instructing the patron to pass the first library item to be checked out of the library under one of the barcode label scanners 16 or 18 (step 50). When the library item is passed under one of the barcode label scanners 16 or 18, the barcode label on the library item is scanned by the barcode label scanner (step 52). The library item ID data read from the scanned barcode label is then conveyed to the personal computer 12 and stored. Subsequently, the personal computer 12 instructs the RFID label reader 34 to broadcast an RFID label query throughout its interrogation space. The library item ID data returned to the RFID label reader 34 by each RFID label in the interrogation space in response to the RFID label query, is conveyed to the personal computer 12. The personal computer 12 in turn examines the received library item ID data to determine if more then one RFID label responded to the RFID label query (step 56). If the personal computer 12 determines that more than one RFID label has responded to the broadcast RFID label query, the personal computer 12 detects an error condition and in response, presents an error message on the touchscreen display 14 to notify the patron of the error condition (step 58). At this point, the library item checkout process reverts back to step 50. As a result, the patron is required to re-scan the barcode label on the library item if the patron still wishes to check that library item out of the library.

At step 56, if the personal computer 12 determines that only a single RFID label has responded to the broadcast RFID label query, the personal computer 12 then performs a check to determine if the library item ID data received from both the barcode label scanner 16 or 18 and the RFID label reader 34 is coincident (step 60). If the library item ID data is not coincident, the personal computer 12 again detects an error condition and in response presents an error message on the touchscreen display 14 to notify the patron of the error condition (step 58). At this point, the item checkout process reverts back to step 50. As a result, the patron is required to re-scan the barcode label on the library item if the patron still wishes to check that library item out of the library.

At step 60, if the library item ID data received from both the barcode label scanner and the RFID label reader is coincident, the personal computer 12 presents a prompt on the touchscreen display 14 instructing the patron to place their library identification (ID) card beneath the ID card barcode label scanner 22. When the ID card is properly positioned, the existence of the ID card is sensed by the ID card presence sensor 24. The ID card presence sensor 24 in turn signals the personal computer 12, which in response instructs the ID card barcode label scanner 22 to read the barcode label on the ID card. Once the barcode label on the ID card has been read, the ID card barcode scanner 22 conveys the read ID card data to the personal computer 12. Upon receipt of the read ID card data, the personal computer 12 conveys the read ID card data to the circulation server 42 of the ILS 38 with a checkout request (step 62)

In response to the checkout request, the circulation server 42 examines the database 44 to confirm the validity of the read ID card. If the ID card is valid, the circulation server 42 retrieves the patron account associated with the ID card to determine the status of the account and whether the patron is authorized to check items out of the library (step 64). If the circulation server 42 determines that the read ID card is invalid or that the patron is unauthorized to check items out of the library (i.e. because the patron has overdue fines, is suspected of theft etc.), the circulation server 42 instructs the personal computer 12 to terminate the checkout process. The personal computer 12 in response presents a message on the touchscreen display 14 advising the patron that the self-checkout system is unavailable (step 66). At step 64, if the circulation server 42 determines that the read ID card is valid and that the patron is authorized to check items out of the library, the circulation server 42 signals the personal computer 12. The personal computer 12 in response presents a message on the touchscreen 14 instructing the patron to place the library item on the processing plate of the EAS label desensitizer 30. The personal computer 12 then signals the library item measurement sensor 26 to scan its sensing space and calculate the thickness of the library item placed on the processing plate in the manner described above.

The personal computer 12 then examines the records stored in the security database 37 (step 68) to determine if a library item record corresponding to the library item ID data read from the library item being checked out exists (step 70). If no library item record corresponding to the library item ID data exists in the security database 37, a record for the library item including the calculated thickness of the library item placed on the processing plate of the EAS label desensitizer 30, the library item ID data corresponding to the barcode and RFID data on the library item, the current date and time, the checkout station being used and the ID number of the patron is created and the security database 37 is updated (step 72). With the security database 37 updated, the checkout process for the library item is approved (step 74).

In this case, the personal computer 12 signals the EAS label desensitizer 30. In response, the EAS label desensitizer 30 exams the library item presence sensor 32 to ensure the library item is properly positioned on its processing plate and if so, emits a strong magnetic field in its deactivation space to desensitize the EAS label on the library item. The personal computer 12 then presents a prompt on the touchscreen display 14 asking the patron if another library item is to be checked out. If no other library item is to be checked out, the personal computer 12 signals the receipt printer 20 to print a receipt for the patron. If another library item is to be checked out, the process reverts back to step 50.

At step 70, if a library item record corresponding to the library item ID data read from the library item being checked out exists in the security database 37, the personal computer 12 compares the thickness of the library item calculated by the ultrasonic sensor unit against the thickness value in the library item record to determine if the calculated thicknesses are generally coincident (step 76). If the calculated thickness falls within a preset tolerance of the thickness value in the record (step 76), the personal computer 12 proceeds to step 74 and the checkout process is completed as described above.

At step 76, if the calculated thickness is not within the preset tolerance of the thickness value in the library item record, a check is made to determine if the calculated thickness is greater than the thickness value in the library item record (step 78). If the calculated thickness is greater than the thickness value in the library item record, the personal computer 12 signals the ILS 38 to terminate the checkout process (step 80) and an error message is presented on the touchscreen display (step 82). At this point, the item checkout process reverts back to step 50. As a result, the patron is required to re-scan the barcode label on the library item if the patron still wishes to check that library item out of the library.

At step 78, if the calculated thickness is less than the thickness value in the library item record, signifying that an extra library item was present on the processing plate of the EAS label desensitizer 30 when the record for the library item was created, the personal computer 12 retrieves the library item record from the security database 37, which as mentioned above comprises patron's ID information, the checkout station, the time and date on which the library item record was created and the calculated library item thickness (step 84). The personal computer 12 then uses the retrieved information to record a suspicious transaction in the security database 37 associated with the patron who conducted the transaction that resulted in the library item record being created for the library item (step 86). The personal computer 12 then updates the thickness value of the library item record in the security database 37 using the calculated thickness (step 72) and then proceeds to the step 74 to complete the checkout process as described above.

Although the above process records a suspicious transaction event whenever the calculated thickness of a library item is less than the thickness value in the corresponding library item record retrieved from the security database 37, those of skill in the art will appreciate that suspicious transaction events can be recorded whenever an error condition is detected by the personal computer 12. In this manner, all failed transactions for patrons can be tracked allowing patrons that are likely abusing the self-checkout system 10 or are simply unable to use effectively the self-checkout system to be identified. The suspicious transaction events can then be used to alter the status of patron accounts in the ILS 38 thereby to prevent patrons suspected of abuse from using the self-checkout system 10.

As will be appreciated, the self-checkout system 10 inhibits item theft by blocking transactions where more than one library item is detected as being placed on the library item measurement sensor 26.

If desired, following step 70, prior to using the calculated thickness output by the library item measurement sensor 26 to create and store a library item record when it is determined that the library item is being checked out for the first time, the calculated thickness can be compared to upper and/or lower limits established for the library item type. In this manner, creation of library item records that include obviously incorrect thickness information can be avoided.

Although the library item measurement sensor 26 is described as comprising an ultrasonic sensor unit for measuring the thickness of library items, those of skill in the art will appreciate that alternatives are available. For example, the library item measurement sensor 26 may measure the thickness of each library item using optical triangulation or optical time of flight sensors. Alternatively, the library item measurement sensor 26 may measure another physical parameter of each library item. For example, the library item measurement sensor 26 may comprise a load cell for measuring the weight of library items, or may comprise an imaging system for measuring the shape of library items.

In the self-checkout system 10, barcode and RFID labels on each library item are read to detect coincidence. If desired, the self-checkout system 10 may also comprise an optical character recognition (OCR) reader to read information from the library item being checked out. In this case, the information read by the OCR reader is compared with the library item ID data read from the barcode and RFID labels to detect coincidence. Of course, only one of a barcode label scanner, RFID label reader or OCR reader or different combinations thereof may be employed.

The checkout software application executed by the personal computer 12 may include program modules including routines, programs, object components, data structures etc. and be embodied as computer readable program code stored on a computer readable medium. The computer readable medium is any data storage device that can store data, which can thereafter be read by a computer system. Examples of computer readable medium include for example read-only memory, random-access memory, CD-ROMs, magnetic tape and optical data storage devices. The computer readable code can also be distributed over a network including coupled computer system so that the computer readable program code is stored and executed in a distributed fashion.

Those of skill in the art will appreciate that the method and self-checkout system described above may be used in other environments besides libraries where it is desired to provide individuals with the ability to remove items from a location once clearance has been granted.

Although particular embodiments have been described with reference to the figures, those of skill in the art will appreciate that variations and modifications may be made without departing from the spirit and scope thereof as defined by the appended claims.

What is claimed is:

1. A method of inhibiting article theft at a location employing at least one self-checkout station and an antitheft security system, each article carrying at least one antitheft security label, said method comprising:
reading identification information from an article;
sensing at least one physical parameter of said article;
retrieving article parameter information from at least one database based on said read identification information;
comparing the sensed at least one physical parameter with the retrieved article parameter information; and
deactivating each antitheft security label carried by the article if the sensed at least one physical parameter generally corresponds with said article parameter information.

2. The method of claim 1 wherein the antitheft security label is deactivated if the sensed at least one physical parameter does not deviate from the retrieved article parameter information by more than a threshold amount.

3. The method of claim 2 wherein said threshold amount is a function of the article type.

4. The method of claim 1 wherein during said sensing, at least one of weight, thickness and shape of the article is sensed.

5. The method of claim 4 wherein said reading comprises reading at least one identification label on said article for said identification information.

6. The method of claim 5 wherein during said reading, at least one of a barcode label and a radio frequency identification (RFID) label on said article is read for said identification information.

7. The method of claim 6 wherein during said reading, both a barcode label and an RFID label on said article are read for said identification information.

8. The method of claim 7 wherein the identification information read from said barcode label and said RFID label is compared to detect coincidence prior to said retrieving, and wherein said retrieving, comparing and deactivating is performed only upon coincide of the identification information read from said barcode label and said RFID label.

9. The method of claim 1 further comprising, if article parameter information for the article does not exist in the at least one database, storing the sensed at least one physical parameter in the at least one database as the article parameter information and performing said deactivating.

10. The method of claim 9 wherein during said sensing, at least one of weight, thickness and shape of the article is sensed.

11. The method of claim 10 wherein said reading comprises reading at least one identification label on said article for said identification information.

12. The method of claim 11 wherein during said reading, at least one of a barcode label and a radio frequency identification (RFID) label on said article is read for said identification information.

13. The method of claim 12 wherein during said reading, both a barcode label and an RFID label on said article are read for said identification information.

14. The method of claim 13 wherein the identification information read from said barcode label and said RFID label is compared to detect coincidence prior to said retrieving, and wherein said retrieving, comparing and deactivating is performed only upon coincidence of the identification information read from said barcode label and said RFID label.

15. The method of claim 1 wherein during said comparing, if the sensed at least one physical parameter does not generally correspond with the article parameter information, determining if the deviation is the result of a likely error in the article parameter information and if so, performing said deactivating.

16. The method of claim 15 further comprising updating the article parameter information using the sensed at least one physical parameter when the deviation is the result of a likely error.

17. The method of claim 15 further comprising recording a suspicious transaction event.

18. The method of claim 17 further comprising, if article parameter information for the article does not exist in the at least one database, storing the sensed at least one physical parameter in the at least one database as the article parameter information and performing said deactivating.

19. The method of claim 18 wherein during said sensing, at least one of weight, thickness and shape of the article is sensed.

20. The method of claim 19 wherein said reading comprises reading at least one identification label on said article for said identification information.

21. The method of claim 20 wherein during said reading, at least one of a barcode label and a radio frequency identification (RFID) label on said article is read for said identification information.

22. The method of claim 21 wherein during said reading, both a barcode label and an RFID label on said article are read for said identification information.

23. The method of claim 22 wherein the identification information read from said barcode label and said RFID label is compared to detect coincidence, prior to said retrieving, and wherein said retrieving, comparing and deactivating is performed only upon coincidence of the identification information read from said barcode label and said RFID label.

24. A self-checkout system comprising:
at least one reader for reading information from an article;
at least one sensor for sensing at least one physical parameter of said article;
processing structure communicating with said at least one reader and said at least one sensor and comparing the sensed at least one physical parameter with article parameter information read from at least one database; and
an antitheft security label deactivator for deactivating an antitheft security label carried by the article when the sensed at least one physical parameter generally corresponds to said article parameter information.

25. The self-checkout system of claim 24 wherein said at least one reader comprises at least one of a barcode label reader, a radio frequency identification (RFID) label reader and an optical character recognition (OCR) reader.

26. The self-checkout system of claim 25 wherein said article is a library asset.

27. The self-checkout system of claim 24 wherein said antitheft security label deactivator is conditioned to deactivate the antitheft security label carried by the article when the sensed at least one physical parameter does not deviate from the retrieved article parameter information by more than a threshold amount.

28. The self-checkout system of claim 24 wherein said at least one sensor senses one of article thickness, weight and shape.

29. The self-checkout system of claim 24 wherein said at least one reader reads at least one identification label on said article.

30. The self-checkout system of claim 29 wherein at least one reader reads at least one of a barcode label and a radio frequency identification (RFID) label on said article.

31. The self-checkout system of claim 24 wherein if article parameter information for the article does not exist in the at least one database, said processing structure stores the sensed at least one physical parameter in the at least one database as the article parameter information.

32. The self-checkout system of claim 24 wherein if the sensed at least one physical parameter does not generally correspond with the article parameter information, the processing structure determines if the deviation is the result of a likely error in the article parameter information.

33. The self-checkout system of claim 32 wherein the processing structure also records a suspicious transaction event.

34. A computer readable medium embodying a computer program, said computer program comprising:
computer program code for causing a reader to read identification information from an article;
computer program code for causing a sensor to sense at least one physical parameter of said article;
computer program code for retrieving article parameter information from at least one database based on said read identification information;
computer program code for comparing the sensed at least one physical parameter with the retrieved article parameter information; and
computer program code for causing a deactivator to deactivate each antitheft security label carried by the article if the sensed at least one physical parameter generally corresponds with said article parameter information.
